(19) United States
(12) Patent Application Publication
(10) Pub. No.: US 2008/0035344 A1
(43) Pub. Date: Feb. 14, 2008

(54) DELAYED POLYACRYLAMIDE-CO-ALUMINUM HYDROXYL CHLORIDE GEL

(76) Inventors: Nadir Odeh, Abu Dhabi (AE); Mathew Samuel, Kuala Lumpur (MY); Philippe Enkababian, Balikpapan (ID); Keng Seng Chan, Kuala Lumpur (MY)

Correspondence Address: SCHLUMBERGER TECHNOLOGY CORPORATION;David Cate, IP DEPT., WELL STIMULATION, 110 SCHLUMBERGER DRIVE, MD1, SUGAR LAND, TX, 77478, US

(21) Appl. No.: 11/462,862

(22) Filed: Aug. 7, 2006

(51) Int. Cl. E21B 33/138; C09K 8/44

(52) U.S. Cl. 166/295; 166/300; 523/130; 507/224; 507/225; 507/269; 507/903

(57) ABSTRACT

A delayed gelling system useful in conformance control in the production of petroleum from subterranean formations is disclosed. The gelling system comprises an acidic aqueous solution of acid-soluble or cationic polyacrylamide, an at least partially neutralized acid aluminum salt, an activator comprising a hydroxyl donor, and an optional gel modifier. The gelling system may be pumped into formations with excessive water production and thermally activated in the formation at downhole conditions to form a co-gel of polyacrylamide interspersed in an inorganic gel network to reduce water production.

### FIELD OF THE INVENTION

The invention relates to delayed gelling systems and conformance control in oil and gas reservoirs using the delayed gelling system, and more particularly to delayed gel systems and methods based on mixed crosslinked polyacrylamide and inorganic precipitate-type gels.

### BACKGROUND OF THE INVENTION

The following terms will be used in this document: A “treating fluid” or “treatment fluid” is a fluid that is used for treating a well. In this particular case, it is generally a water shutoff fluid. It should be understood that the same materials and techniques may generally be used for water shut off and for gas shut off and that when we speak of water shut off compositions and methods we intend gas shut off to be included. In the case of a delayed water shut off treatment fluid that contains aluminum hydroxyl chloride and urea, the “delayed water shut off gel” is a gel formed by a delayed water shut off treatment fluid. For example, a delayed water shut off treatment fluid that contains acid-soluble polyacrylamide, aluminum hydroxyl chloride and urea according to the present invention will typically gel in about 1 to about 20 hours (this is called the “working time” and depends upon such factors as the component concentrations and the temperature).

In subsurface formations, naturally occurring rocks are generally permeable to fluids such as water, oil, or gas (or some combination of these fluids). It is believed that the rock in most oil-bearing formations was completely saturated with water prior to the invasion and trapping of petroleum. The less dense hydrocarbons migrated to trap locations, displacing some of the water from the formation, the trap becoming a hydrocarbon reservoir. Thus, reservoir rocks normally contain both petroleum hydrocarbons (liquid and gas) and water. Sources of this water may include flow from above or below the hydrocarbon zone, flow from within the hydrocarbon zone, or flow from injected fluids and additives resulting from production activities. This water is frequently referred to as “connate water” or “formation water” and becomes produced water when the reservoir is produced and these fluids are brought to the surface. Produced water is any water that is present in a reservoir with the hydrocarbon resource and is produced to the surface with the crude oil or natural gas. When hydrocarbons are produced, they are typically brought to the surface as a produced fluid mixture.

As production continues, it is common that an increasing proportion of the produced fluids is water. There are some strategies that can be used to restrict water from entering the well bore. These involve mechanical blocking devices or chemicals that “shut off” water-bearing subterranean formations, channels, or fractures within the formation and prevent water from making its way to the well. Operators have used various mechanical and well construction techniques to block water from entering the well. Several examples of these techniques are straddle packers, bridge plugs, casing patches, and cement plugs (or cement squeezes).

These techniques have been used for many years, but they do not work well in all applications. Mechanical approaches can be used to block casing leaks, or flow behind the pipe without flow restrictions, and to block unfractured wells with barriers to cross flow. However, these approaches may not be effective in solving other types of water production problems. Another drawback of these mechanical methods is the physical restriction left in the wellbore. This restriction can, in some cases, prevent the subsequent perforation or the mechanical isolation of an interval located below the treated interval.

Another approach to shutting off unwanted water or gas production while allowing continued production of oil or gas involves the use of gel-based shut-off fluids. These fluids are introduced deep into the pore matrix of the formation that is producing unwanted water or gas, and into the channel or fracture network, where they undergo physical transformation from a solids free squeezable liquid to a highly viscous or rigid material. Two families of gel-based shut-off fluids are typically used. Polymer gels typically contain an acrylamide gel and a cross-linker. The physical transformation occurs when the polymer is cross-linked. This process is triggered by time and/or temperature and can be delayed to allow sufficient time for placement in the target formation. Inorganic gels typically contain a metallic or silicate salt and an activator. The physical transformation occurs when the pH of the solution is modified by chemical reaction of the activator. This process is also triggered by time and/or temperature and can also be delayed to allow sufficient time for placement into the target formation.

Gel-based shut-off treatments are typically formulated to “set” by precipitation or cross-linking after several hours so that enough time is available for the treatment to be pumped and squeezed into the target formation. This delay time is also known as working time.

U.S. Pat. No. 4,039,029 to Gall teaches complexing a multivalent cation cross-linking agent with a retarding anion. The complex prevents gelation of the polymer during injection until the complex dissociates in the formation. Similarly, Needham et al, “Control of Water Mobility Using Polymers and Multivalent Cations,” SPE Paper No. 4747, discloses injecting partially hydrolyzed polyacrylamide with aluminum citrate. The citrate sequesters the aluminum cation until the gel components are in place in the formation. The aluminum cation is freed from the complex over time to cross link the polymer. The resulting gel reduces the permeability of the porous media to water.

U.S. Pat. No. 4,889,563 to Parker et al. teaches a process for retarding and controlling the formation of gels or precipitates from aluminum hydroxyl chloride with a delayed activator such as urea or hexamethylene-tetramine, optionally with gelling additives such as citrate and tartrate and/or crystallizing additives such as sulfate, oxalate and succinate.

Background information on conformance control of a petroleum reservoir with a delayed gel can be found in Borling et al., “Pushing Out the Oil with Conformance Control,” Oilfield Review, p. 44 (April 1994). This reference discusses conformance control with, among others, (i) the DGS inorganic gel system, based on aluminum hydroxyl chloride-urea, (ii) the MARA-SEAL polymer gel system, based on partially hydrolyzed polyacrylamide-chromium acetate, and (iii) the BP/ARCO gel system based on partially hydrolyzed polyacrylamide-aluminum citrate.

U.S. Pat. No. 5,125,456 and U.S. Pat. No. 5,957,203, both to Hutchins et al., disclose the formation of visible gels from high molecular weight polyacrylamide polymers at concentrations below 2 weight percent with an inorganic crosslinking agent such as polyvalent metals at less than 200 ppm by weight.

U.S. Pat. No. 5,382,371 to Stahl et al. discloses acrylamide copolymers comprising N-vinyl amides such as N-vinyl lactam and hydrophilic vinyl-containing sulfonic acid such as 2-acrylamido-2-methylpropane sulfonic acid (AMPS).

U.S. Pat. No. 5,010,954 to Falk discloses carboxylate-containing polymers such as partially hydrolyzed polyacrylamide (PHPA) crosslinked with chromium carboxylate species such as chromium acetate.

Cross-linking of a polyacrylamide solution provides materials having excellent physical properties, such as gel strength, to facilitate physical plugging of pores or fissures. When subjected to elevated temperature, some of the amide group are converted to carboxylate groups, forming PHPA, and become susceptible to ionic cross-linking with metal ions. These metal ions are typically provided as soluble chemical complexes in which the metal ions are associated with small inorganic or organic groups called ligands. Simple inorganic metal ions are typically not used as in-situ cross-linkers because the cross-linking reaction is difficult to control and/or to delay. Trivalent aluminum ion is one of the metal ions that are not used because the cross-linking reaction cannot be controlled or delayed, i.e. it gels the PHPA immediately. Furthermore, a polyacrylamide gel crosslinked with trivalent aluminum ions would be expected to exhibit poor long term gel strength (it would undergo degradation over time) and would therefore be unsuitable for long term zone shut-off.

There is a need for a delayed polyacrylamide gelling system based on crosslinking with aluminum ions in which the working time can be controllably delayed and which obtains a stable gel suitable for long term zonal shut-off for conformance control.

### SUMMARY OF THE INVENTION

The delayed gelling system of this invention is an organic-inorganic co-gel in which the immediate cross-linking that might otherwise result upon mixing a partially hydrolyzed polyacrylamide with aluminum is delayed, by using a gel-forming acid aluminum, a partially hydrolyzed or hydrolysable polyacrylamide soluble in acidic pre-gel conditions, and a delayed activator to elevate the pH to activate co-cross-linking of the polyacrylamide and aluminum into a co-gel. The gelling system of this invention is based on an acidic aqueous solution of acid-soluble polyacrylamide (PAM) using an at least partially neutralized acid aluminum salt, such as aluminum hydroxyl chloride (AHC), with a Lewis base activator for delayed gelling, and divalent anions as optional gel modifiers. Fluids comprising PAM, AHC and the delayed gelling agent have an adjustable rheology for pumping and injection into a reservoir. When set, this system provides a three-dimensional interconnected polymer network structure bound into an inorganic gel structure useful in conformance control.

In one embodiment, the present invention provides a delayed gelling system in the form of an acidic aqueous solution of acid-soluble, metal cross-linkable polymer, an at least partially neutralized acid aluminum salt and an activator comprising a Lewis base source. The pre-gel may have a pH greater than 3 and not more than 5 in one embodiment or from about 4 to 4.5 in another embodiment. The polymer in an embodiment can be polyacrylamide (PAM) which can be partially hydrolyzed to introduce cross-linking sites, or may be hydrolysable at the elevated temperatures seen in subterranean formations. The polymer may be cationic to facilitate acid solubility and stability. In another embodiment the polymer is amphoteric or zwitterionic. In other embodiments, the PAM includes neutral or inert comonomers that can facilitate delaying the set time, which may result from steric hindrance effects. The polymer may have a weight average molecular weight from 100,000 to 10 million or more, less than 500,000 in an embodiment, greater than 1 million in another.

In other embodiments, the polymer can be an alkyl substituted or unsubstituted polyacrylic acid, polymethacrylic acid, polyacrylamide, hydrolyzed polyacrylonitrile, polyvinylpyrrolidone, a combination thereof, or the like. As representative examples there may be mentioned poly(methylene-bis-acrylamide); poly(N,N′-dimethyl acrylamide); poly (2-hydroxyethylmethacrylate), poly(2-hydroxyethylacrylate), glycolated polyacrylamide, polyacrylamide copolymer, and the like.

The partially neutralized aluminum salt in one embodiment can have the formula Alₙ(OH)ₘXₚ wherein X is an inorganic or organic ion or a mixture thereof with valence q, wherein pq+m=3n and a ratio m/3n is between 0.3 and 0.85. The at least partially neutralized aluminum salt may be AHC.

The Lewis base source in one embodiment is selected from pH-increasing agents that hydrolyze or decompose thermally to release a base or consume an acid, such as, for example, quaternary ammonium salts, urea and substituted ureas, hexamethylene tetramine, cyanates, coordination compounds such as cupric ammonium sulfate, salts of a strong base and a weak acid, combinations thereof, or the like. In one embodiment, the Lewis base source is selected from urea and N,N′-dimethyl urea. In another embodiment, the Lewis base source is, for example, urea, N,N′-dialkyl urea, semicarbazide or the like; thiourea, dithiobiurea, dithiobiuret or the like; and/or alkyl-substituted or unsubstituted triazole, thiadiazole, thiosemicarbazide or the like; or any combination of these.

In another embodiment, the delayed gelling system can include a divalent or trivalent transition metal, e.g. titanium, iron, nickel, copper, zinc, manganese, or the like. The system can additionally or alternatively include: one or more organoaluminum compounds, e.g. aluminum acetate, aluminum formate, aluminum acetylacetonate, aluminum lactate, aluminum tributoxide, or the like; and/or one or more inorganic aluminum compounds, e.g. hydrated aluminum ammonium sulfate, aluminum potassium sulfate, aluminum metaphosphate, aluminum nitrate, aluminum perchlorate, or the like.

The delayed gelling system may also include a gel modifier selected from polyvalent anions, such as, for example, sulfates, tartrates, citrates, lactates, oxalates, succinates, and the like, and combinations thereof.

The aqueous solution may include, in an embodiment, from 0.05 to 50 weight percent of the cationic polyacrylamide, from 0.5 to 20 weight percent of the partially neutralized acid aluminum salt, from 0.5 to 20 weight percent of the activator, and when present, from 0.1 to 20 weight percent of the gel modifier.

Another aspect of the invention is a delayed gelling system having utility in conformance control, comprising an aqueous solution of from 0.1 to 10 weight percent cationic polyacrylamide and from 1 to 15 weight percent aluminum hydroxyl chloride, stable below 30° C. or below 50° C., and an effective amount of an activator selected from the group consisting of urea, alkyl-substituted urea, hexamethylene tetramine, cyanates, and combinations thereof, to form a time-delayed co-gel of polyacrylamide and hydrolyzed aluminum chloride at a temperature above 50° C. or above 65° C.

A further embodiment of the invention is a polyacrylamide-inorganic co-gel obtained by gelation of the delayed gelling system described above.

Another embodiment of the invention is a method of forming a delayed polyacrylamide-inorganic co-gel that includes the steps of preparing the aqueous solution of polyacrylamide, partially neutralized acid aluminum salt, activator and optional gel modifier described above, and heating the aqueous solution to a temperature effective to form a time-delayed co-gel of polyacrylamide and hydrolyzed aluminum chloride. In one embodiment, the aqueous solution is prepared at a temperature from 0 to 50° C. and the co-gel is set at a temperature above 50° C., above 65° C., or above 80° C., with a setting time from 2 hours to 10 days. In another embodiment, the aqueous solution is injected into a portion of a subterranean formation and set in place at the formation temperature to inhibit permeability of the portion of the formation.

A further embodiment of the invention is directed to a recovery system, comprising a subterranean formation penetrated by a well, and a polyacrylamide-inorganic co-gel formed by the method just described in a portion of the formation.

Further still, an embodiment of the invention is the polyacrylamide-inorganic co-gel obtained by the method described above.

### BRIEF DESCRIPTION OF THE DRAWINGS

FIG. 1 is a graph showing the time to set for a delayed gelling system at 127° C. based on 9.3 weight percent aluminum hydroxyl chloride (AHC), and 5 weight percent of an emulsion of 20-50 weight percent high molecular weight cationic polyacrylamide (CPAM) as a function of N,N′-dimethyl urea (DMU) concentration from 3 to 8 weight percent DMU.

FIG. 2 is a graph showing the time to set for a delayed gelling system at 127° C. based on 9.3 weight percent AHC and 1.3 weight percent DMU as a function of CPAM emulsion concentration from 1 to 5 weight percent of the CPAM emulsion of FIG. 1.

FIG. 3 is a graph showing the time to set for a delayed gelling system at 127° C. based on 1.3 weight percent DMU and 5 weight percent of the CPAM emulsion of FIG. 1 as a function of AHC concentration from 4 to 9 weight percent AHC.

FIG. 4 is a graph showing the viscosity for a delayed gelling system at 77° C. based on 9.3 weight percent AHC and 1.3 weight percent DMU as a function of the concentration from 1 to 5 weight percent the CPAM emulsion of FIG. 1.

### DETAILED DESCRIPTION OF EMBODIMENTS OF THE INVENTION

The gelling system of the present invention comprises a delayed co-gel formed from an acidic aqueous solution of acid-soluble polyacrylamide and an at least partially neutralized acid aluminum salt, with additional gelling control by a Lewis base and optional polyvalent anionic gel modifiers. The crosslinking reactions of this new system are controllable and robust. The pre-gel fluid before it sets has an adjustable rheology for pumping and placement. When set, this system provides a three-dimensional interconnected polymer molecular structure interspersed in and crosslinked by a network of an inorganic gel structure.

As used herein, “polymer” may be used to refer to homopolymers, copolymers, interpolymers, terpolymers, etc. Likewise, a copolymer may refer to a polymer comprising at least two monomers, optionally with other monomers, and may be a random, alternating, block or graft copolymer.

As used herein, when a polymer is referred to as comprising a monomer, the monomer is present in the polymer in the polymerized form of the monomer or in the derivative form the monomer. A “cationic polymer” is a polymer with positively charged ionic sites spaced along the polymer; an “anionic polymer” is one with negatively charged ionic sites; and an “amphoteric polymer” is one with both positively and negatively charged ionic groups. The ionic sites can be either integral or pendant with respect to the polymer backbone. The terms “cationic polymer” and “anionic polymer” each encompass amphoteric polymers, without regard to whether one charge predominates over the other, or whether the polymer is zwitterionic.

The polyacrylamide (PAM) suitable in the present invention is generally a water-soluble polymer or copolymer of acrylamide that is soluble in acidic solutions, e.g. at a pH less than 6, from 3 to 5 in one embodiment, and especially from 4 to 4.5. The polyacrylamide or other polymer should also be stable in acidic solution with partially neutralized acid aluminum salts such as aluminum hydroxyl chloride (AHC), i.e. it should not prematurely crosslink before the desired set time.

The polyacrylamide may be anionic, cationic, or amphoteric. Anionic polyacrylamide or APAM can be made by copolymerizing an acidic comonomer such as acrylic acid or methacrylic acid with the acrylamide, or more commonly by hydrolysis or other derivatization of a portion of the amide groups. For example, polyacrylamide can be partially hydrolyzed at the formation conditions. Although not intending to be bound by theory, it is thought that the anionic groups can facilitate cross-linking by providing reactive sites for the polyvalent cationic aluminum species that are present upon activation. In an embodiment, only a very small amount of anionic groups are required for the desired cross-linking density, e.g. a degree of hydrolysis of just 0.01 to 0.1 (100 to 1000 ppm mole basis) may be sufficient in some embodiments. In one embodiment, this degree of hydrolysis is achieved fairly quickly at the elevated temperature conditions of subterranean formations, i.e. before the inorganic (aluminum) gel sets.

Cationic polyacrylamide or CPAM is a copolymer of acrylamide and a cationic monomer in an amount to introduce the desired charge density into the copolymer, although it is also known to form a derivative of polyacrylamide via modification of the amide groups to introduce the pendent cationic moieties into the polymer, and such cationic polyacrylamides are also suitably employed in the invention. Although not fully understood and not wishing to be bound by theory, the presence of the cationic comonomer appears to impart acid solubility to the polymer and to play a role in helping to stabilize the system to facilitate control of the delayed gel formation.

The cationic comonomer typically introduces pendant quaternary amines into the copolymer, such as, for example, 4-vinylpyridine or a beta-acryloxyalkylenetrialkylammonium salt of the formula CH2=C(R¹)[CONH—R²N⁺(R³)₃]Z⁻ wherein Z is an anion (such as chloride, bromide, iodide, hydroxide, carbonate, phosphate, nitrate, etc.); R¹ and R³ are the same or different and are independently selected from hydrogen and C₁ to C₁₀ alkyls, and R² is C₁ to C₁₀ alkylene, e.g. methacryloxyethylenetrimethylammonium chloride or acryloxyethylenetrimethylammonium hydroxide monomers. In various embodiments, the R¹, R² and R³ moieties in the beta-acryloxyalkylenetrialkylammonium salt may each independently have from 1 to 5 carbon atoms, from 1 to 3 carbon atoms, 1 or 2 carbon atoms, or especially 1 carbon atom.

The CPAM may have a cationicity, defined as the molar fraction of cationic comonomer in the CPAM, from 0.001 to 0.999. In a first embodiment, the CPAM has a cationicity less than 0.05 (corresponding to a fraction of acrylamide and other nonionic and/or anionic monomer units of more than 0.95), and in a second embodiment greater than 0.05 (corresponding to a fraction of acrylamide and other nonionic monomer units of less than 0.95). In the first embodiment, the cationicity may range from 0.001 to 0.05, from 0.005 to 0.05, from 0.01 to 0.05, from 0.02 to 0.05, or from 0.025 to 0.05, and/or the fraction of acrylamide units can range from 0.95 to 0.995, from 0.95 to 0.99, from 0.95 to 0.98, or from 0.95 to 0.975; and in the second, cationicity may range from 0.05 to 0.99, with a lower limit of at least 0.05, 0.1, 0.25, 0.4, 0.5, 0.6, 0.7, 0.8, 0.9 or 0.95, and/or the fraction of acrylamide units can range from 0.01 to 0.95, with an upper limit of no more than 0.95, 0.9, 0.75, 0.6, 0.5, 0.4, 0.3, 0.2, 0.1 or 0.05.

The acid-soluble PAM can have a molecular weight from 100,000 or less to 20 million or more, depending on the pre-set rheology and gel characteristics desired. As used herein, molecular weight refers to weight average molecular weight unless otherwise specified. In general, a higher molecular weight leads to a more rigid gel, whereas lower molecular weights yield solutions of lower viscosity that may be more easily pumped. Higher molecular weight PAM is generally used at a lower concentration than the lower molecular weight PAM. In various other embodiments, the PAM has a molecular weight with a lower limit that is at least 250,000, at least 500,000, at least 750,000, at least 1 million, at least 2 million, at least 3 million, at least 4 million, at least 5 million, at least 6 million, at least 7.5 million, at least 8 million, at least 9 million, at least 10 million or at least 15 million; and with an upper limit that is less than 15 million, less than 10 million, less than 7.5 million, less than 5 million, less than 3 million, less than 2 million, less than 1 million, less than 750,000, less than 500,000, or less than 300,000; or a within a range from any lower limit value to any higher upper limit value.

The PAM can be employed in the pre-gel solution in an amount effective to form a gel of the desired morphology, and also to provide a pre-gel of the desired rheological properties. In a general embodiment the PAM comprises from 0.05 to 50 weight percent of the pre-gel solution, and in various other embodiments the PAM can have a lower limit of at least 0.1, 0.15, 0.2, 0.25, 0.3, 0.4, 0.5, 1, 1.5, 2, 2.5, 3, 4, 5, 8 or 10 percent by weight, an upper limit of not more than 30, 25, 20, 15, 10, 8, 5, 4, 3, 2.5, 2, 1.5, or 1 percent by weight, or a range from any lower limit to any higher upper limit, e.g. from 1 to 10, from 1 to 5, or from 0.2 to 2.5 weight percent. The PAM can be added to or mixed with the other components of the pre-gel solution in the form of a solid, aqueous solution or water-in-oil emulsion. For high molecular weight PAM especially, the PAM is commercially available in emulsion form.

Other polymers that can be used in addition to or instead of the PAM include alkyl substituted or unsubstituted polyacrylic acid, polymethacrylic acid, polyacrylamide, hydrolyzed polyacrylonitrile, polyvinylpyrrolidone, a combination thereof, or the like. As representative examples there may be mentioned poly(methylene-bis-acrylamide); poly(N,N′-dimethyl acrylamide); poly (2-hydroxyethylmethacrylate), poly(2-hydroxyethylacrylate), glycolated polyacrylamide, polyacrylamide copolymer, and the like. For convenience reference is made herein to PAM as a non-limiting example.

The at least partially neutralized acid aluminum salt has the general formula Alₙ(OH)ₘXₚ wherein X is a mineral or organic ion or a mixture thereof with average valence q, wherein pq+m=3n and a ratio m/3n is between 0.3 and 0.833 or 5/6. In an embodiment, the ratio m/3m is between 0.3 and 0.8. As mineral ions there may be mentioned chloride, bromide, iodide, phosphate, nitrate, sulfate, and the like; and as organic ions, formate, acetate, propionate, butyrate, tartrate, citrate, lactate, oxalate, succinate, and the like. Anionic groups in the PAM can also serve as the organic ion X in the acid aluminum salt in one embodiment. The partially neutralized aluminum salt may conveniently be aluminum hydroxyl chloride (AHC), also called aluminum hydroxychloride or dialuminum chloride pentahydroxide (CAS 12042-91-0), e.g. Al₂(OH)₅Cl·2.5(H₂O).

The partially neutralized acid aluminum salt is readily soluble in mildly acidic media, e.g. a pH below 3 or 4, and by itself forms a gel or precipitate when the pH is raised above 4.5 or 5, for example. In an embodiment, raising the pH also allows the acid aluminum salt to function as a latent cross-linking agent for the PAM, and/or to release aluminum(III) or other species that cross-link the PAM.

In a general embodiment, the partially neutralized acid aluminum salt comprises from 0.5 to 20 weight percent of the pre-gel solution. As used herein, the determination of the weight percentage of the partially neutralized acid aluminum salt in the pre-gel solution excludes any PAM present as X ions from the weight of the aluminum salt, but includes the PAM in the total weight of the solution. In various embodiments, the partially neutralized acid aluminum salt has a lower concentration limit in the pre-gel solution of at least 0.5, 1, 2, 2.5, 3, 4, or 5 weight percent, an upper concentration limit of not more than 20, 15, 10, 8, 5, or 3 weight percent, or a concentration range from any lower limit to any higher upper limit, e.g. from 1 to 10, from 3 to 10, or from 4 to 8 weight percent.

In another embodiment, the weight ratio of PAM to the partially neutralized acid aluminum salt ranges from 1:10 to 10:1, preferably from 3:8 to 8:3. In one embodiment, the total amount of PAM and partially neutralized acid aluminum salt used ranges from about 25 to about 600 pounds per thousand gallons (ppt) of aqueous fluid, preferably from about 250 to about 500 ppt.

The delayed activating agent in the pre-gel solution is generally any Lewis base source, i.e. pH adjusting agents that hydrolyze or decompose thermally to release a base or consume an acid, such as, for example: quaternary ammonium salts; urea and substituted ureas including N,N′-dimethyl urea, N,N-dimethyl urea, N,N′-diethyl urea, N,N-diethyl urea, N,N′-ethyl methyl urea, and N,N-ethyl methyl urea, especially N,N′-dimethyl urea; coordination compounds such as cupric ammonium sulfate for example; salts of a strong base and a weak acid; combinations thereof, and the like.

Lewis bases have a lone pair of electrons that can coordinate with an electron-deficient species, such as a proton. In the presence of water, Lewis bases can abstract a proton from water and produce hydroxyl ions. Lewis bases are thus sometimes also referred to as hydroxyl donors, even though such reference is technically incorrect and it is understood that the hydroxyl is obtained from water.

As specific representative examples there can be mentioned urea, N,N′-dialkyl urea such as N,N′-dimethyl urea, hexamethylene tetramine, cyanates, semicarbazide, thiourea, dithiobiurea, dithiobiuret, triazole, thiadiazole, thiosemicarbazide or the like, which may be alkyl-substituted or unsubstituted, or any combination of these. Cationic groups in the PAM, if present, can also facilitate activation in one embodiment of the invention. In a general embodiment, the activator comprises from 0.5 to 20 weight percent of the pre-gel solution, and in various other embodiments has a lower concentration limit of at least 0.5, 1, 3 or 5 weight percent; an upper concentration of no more than 20, 15, 10, 8 or 5 weight percent; or a concentration range from any lower limit to any higher upper limit, e.g. 3 to 8 percent by weight of the pre-gel solution. In one embodiment, the weight ratio of AHC to activator is generally from about 1:6 to about 2:1.

The gel modifier which is present in the pre-gel solution in one embodiment may be a polyvalent anion such as, for example, tartrate, citrate, sulfate, lactate, oxalate, succinate, or the like. The gel modifiers can affect either or both of the gel formation reaction rate and the morphology of the resulting gel. Unlike the prior art partially hydrolyzed polyacrylamide gelling systems in which they function as gel retardants, citrates and tartrates are active accelerators in the present co-gel system, as are oxalates, sulfates and lactates to a lesser extent.

In a general embodiment, the gel modifier, when present, comprises from 0.1 to 20 weight percent of the pre-gel solution. In various embodiments, the gel modifier has a lower concentration limit in the pre-gel solution of at least 0.1, 0.5, 1, 2, 2.5, 3, 4, or 5 weight percent, an upper concentration limit of not more than 20, 15, 10, 8, 5, 3, or 1 weight percent, or a concentration range from any lower limit to any higher upper limit, e.g. from 1 to 10, from 3 to 10, or from 4 to 8 weight percent.

The delayed gelling system can also include other metal compounds that can facilitate crosslinking of the polymer and/or serve as a cationic counterion to the gel modifier. These metal compounds can include any divalent or trivalent transition metal with unfilled d-orbitals, e.g. titanium, iron, nickel, copper, zinc, manganese, or the like. The system can additionally or alternatively include: one or more organoaluminum compounds, e.g. aluminum acetate, aluminum formate, aluminum acetylacetonate, aluminum lactate, aluminum tributoxide, or the like; and/or one or more inorganic aluminum compounds, e.g. hydrated aluminum ammonium sulfate, aluminum potassium sulfate, aluminum metaphosphate, aluminum nitrate, aluminum perchlorate, or the like.

The pre-gel solution may also contain various other additives used in water shutoff gel systems such as surfactants, thermal stabilizers, breakers, breaker aids, antifoaming agents, pH buffers, scale inhibitors, water control agents, and cleanup additives, and the like.

The pre-gel solution can be prepared by blending or mixing the components and water together in any particular order using conventional blending and mixing equipment and methods. The pH of the blend components should be maintained so as to avoid precipitation or premature gel formation, especially avoiding localized pH increases when high pH or neutral pH components are added. The blending and storage temperature is also maintained below the activation temperature to ensure that the gel or precipitate is not formed prematurely before the solution is placed in the appropriate location where the gel is desired.

The pre-gel solution is generally prepared shortly before it is used, and then heated to a sufficient temperature to elevate the pH so that gelation is activated. In water- or gas-shutoff applications, also known as conformance control, the pre-gel is prepared to have the rheology required for injection into the reservoir, taking into account the temperature, permeability and fluid content of the formation. The pre-gel is also prepared to give an appropriate set time upon injection into the formation, and the desired gel characteristics. For example, the set time will normally be longer than the time it takes to finish injecting the amount of pre-gel solution for the particular application. The injection of the pre-gel is otherwise similar to familiar shutoff methods known in the art.

### EXAMPLES

Examples 1-4 below illustrate the manner in which the set time and pre-gel viscosity can be determined as a function of PAM concentration, AHC concentration and activator concentration at a particular downhole condition, for a particular polyacrylamide polymer. Co-gel systems were prepared by mixing a commercially available cationic polyacrylamide emulsion (20-50 wt % CPAM, unknown cationicity/molecular weight, in an aqueous emulsion of heavy aliphatic petroleum naphtha, ethylene glycol, ammonium chloride, glycol ether and surfactants) (“CPAM#1 emulsion”), solid dialuminum chloride pentahydroxide (CAS 12042-91-0) (“DCP”), solid urea (“U”), and/or solid N,N′-dimethylurea (“DMU”), in water in no particular order in the desired proportions.

### Example 1

### Effect of Activator Concentration

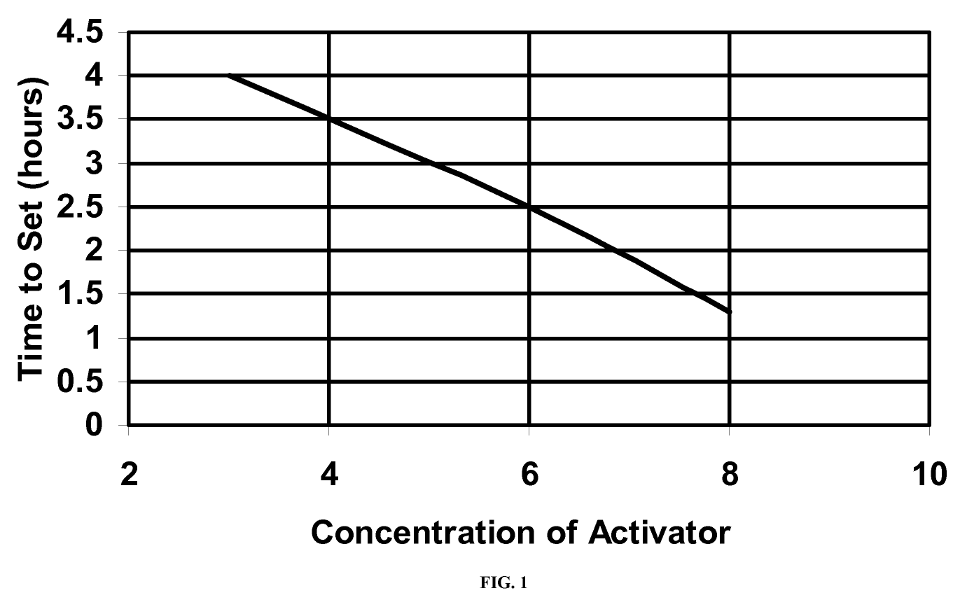

The time to set at 127° C. was observed for a delayed gelling system based on 9.3 weight percent DCP and 5 weight percent CPAM#1 emulsion with DMU at various concentrations from 3 to 8 weight percent. The results seen in FIG. 1 indicate that increasing the DMU concentration decreases the set time in this delayed gelling system. A rigid gel was obtained in all cases.

### Example 2

### Effect of CPAM Concentration

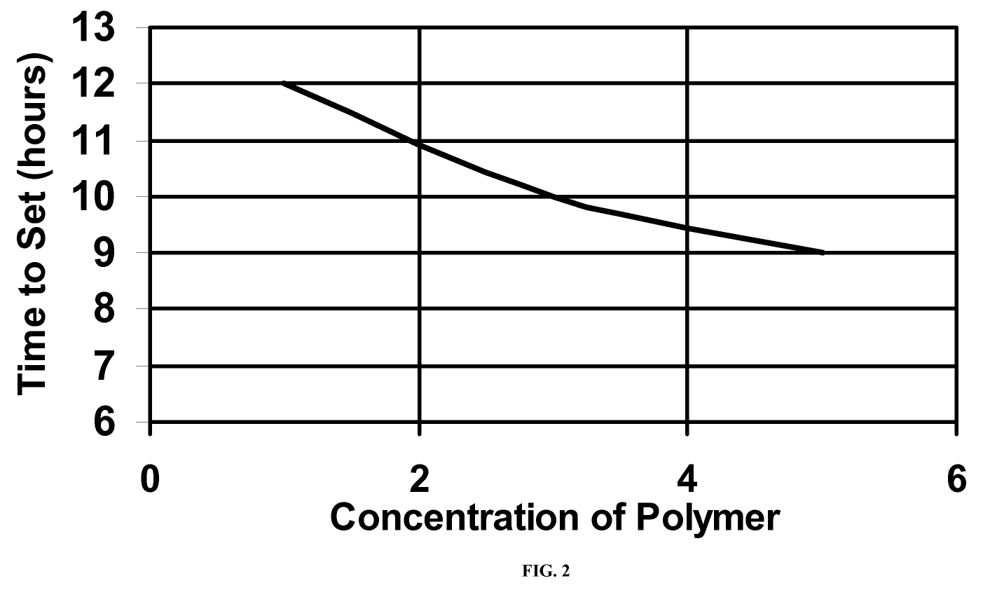

The time to set at 127° C. was observed for a delayed gelling system based on 9.3 weight percent DCP and 1.3 weight percent DMU with CPAM#1 emulsion at various concentrations from 1 to 5 weight percent. The results seen in FIG. 2 show that increasing the CPAM#1 emulsion concentration decreased the set time in this delayed gelling system. A rigid gel was obtained in all cases.

### Example 3

### Effect of DCP Concentration

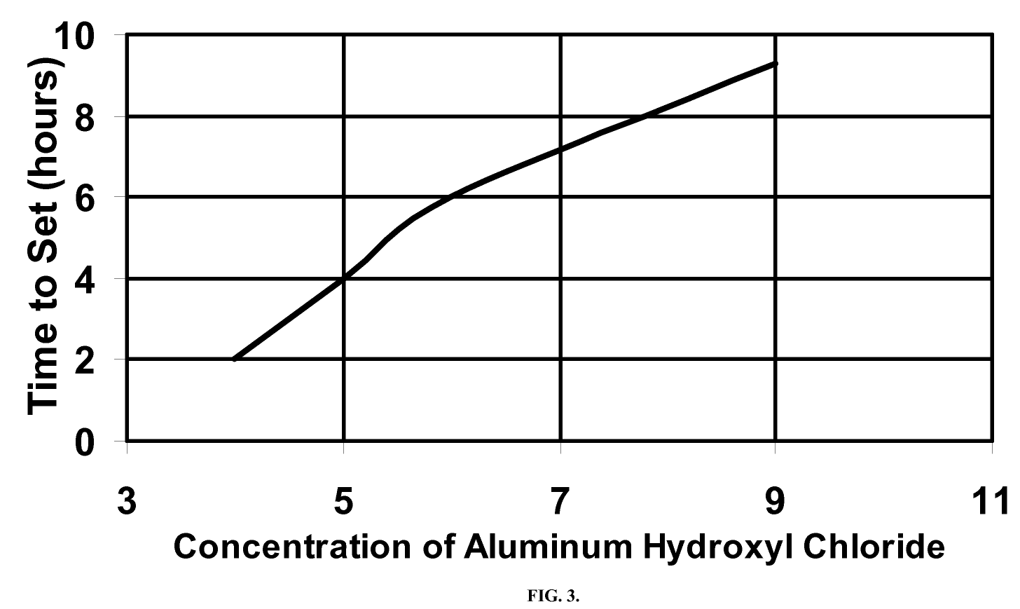

The time to set at 127° C. was observed for a delayed gelling system based on 1.3 weight percent DMU and 5 weight percent of the CPAM#1 emulsion with DCP at various concentrations from 4 to 9 weight percent. The results illustrated in FIG. 3 show that the set time increased with increasing DCP concentration in this delayed gelling system. A rigid gel was obtained in all cases.

### Example 4

### System Viscosity

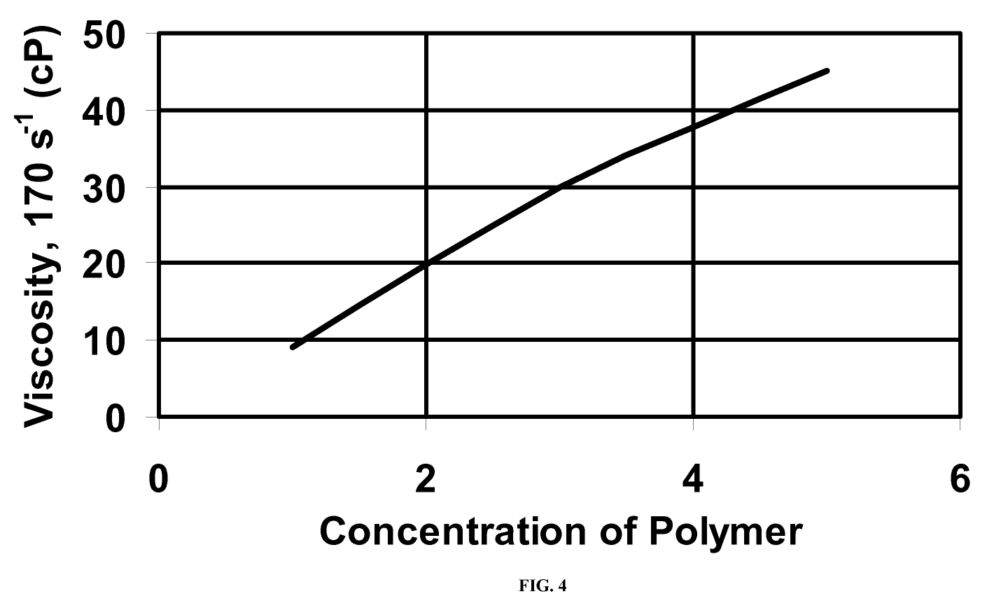

The viscosity at 77° C. and a shear rate of 170 reciprocal seconds was measured for freshly prepared delayed gelling systems based on 9.3 weight percent DCP and 1.3 weight percent DMU for various concentrations from 1 to 5 weight percent of the CPAM#1 emulsion. As seen in FIG. 4, the viscosity increased with increasing CPAM concentration, but the pre-gel solution was pumpable and injectable into a formation (less than 50 cp) at all CPAM#1 emulsion concentrations evaluated.

Although the invention is described in terms of shutoff applications, it is to be understood that it is applicable to any treatment in which a delayed gelling system is used. For example, the gelling system could also be used for fluid loss control from a wellbore, or to plug a formation regardless of the purpose for doing so.

Each of the patents, publications and other references mentioned herein are hereby incorporated herein by reference in their entirety for the purpose of US patent practice and other jurisdictions where permitted.

1. A delayed gelling system, comprising:
an acidic aqueous solution of an acid-soluble, metal cross-linkable polymer, an at least partially neutralized acid aluminum salt and an activator comprising a Lewis base source, wherein said system has a pH greater than three and not more than 5.

2. (canceled)

3. (canceled)

4. The delayed gelling system of claim 1 wherein the polymer is selected from the group consisting of cationic and amphoteric polymers.

5. (canceled)

6. The delayed gelling system of claim 1 wherein the polymer is selected from polyacrylic acids, polymethacrylic acids, polyacrylamides, hydrolyzed polyacrylonitriles, polyvinylpyrrolidones, and combinations thereof.

7. The gelling system of claim 6 wherein the polymer is selected from poly(methylene-bis-acrylamide); poly(N,N′-dimethyl acrylamide); poly (2-hydroxyethylmethacrylate), poly(2-hydroxyethylacrylate), glycolated polyacrylamide, polyacrylamide copolymer, and combinations thereof

8. The delayed gelling system of claim 6 wherein the polymer comprises a partially hydrolyzed polyacrylamide.

9. The delayed gelling system of claim 8 wherein the polyacrylamide comprises an inert comonomer.

10. (canceled)

11. (canceled)

12. (canceled)

13. (canceled)

14. The delayed gelling system of claim 1 wherein the at least partially neutralized aluminum salt has the formula Alₙ(OH)ₘXₚ wherein X is a mineral or organic ion or a mixture thereof with valence q, wherein pq+m=3n and a ratio m/3n is between 0.3 and 0.85.

15. The delayed gelling system of claim 1 wherein the partially neutralized aluminum salt comprises aluminum hydroxyl chloride.

16. The delayed gelling system of claim 1, further comprising a divalent or trivalent transition metal selected from titanium, iron, nickel, copper, zinc and manganese.

17. The delayed gelling system of claim 1 comprising an organoaluminum compound selected from the group consisting of aluminum acetate. aluminum formate, aluminum acetylacetonate, aluminum lactate, aluminum tributoxide, and combinations thereof.

18. (canceled)

19. The delayed gelling system of claim 1 further comprising an inorganic aluminum compound selected from hydrated aluminum ammonium sulfate, aluminum potassium sulfate, aluminum metaphosphate, aluminum nitrate, aluminum perchlorate, and combinations thereof.

20. The delayed gelling system of claim 1 wherein the activator is selected from the group consisting of urea, alkyl-substituted urea, hexamethylene tetramine, cyanates, and combinations thereof.

21. The delayed gelling system of claim 1 wherein the activator is selected from urea, N,N′-dialkyl ureas, semicarbazide and combinations thereof.

22. The delayed gelling system of claim 1 wherein the activator is selected from thiourea, dithiobiurea, dithiobiuret, and combinations thereof.

23. The delayed gelling system of claim 1 wherein the activator is selected from alkyl-substituted or unsubstituted triazole, thiadiazole, thiosemicarbazide, and combinations thereof.

24. The delayed gelling system of claim 1 further comprising a gel modifier selected from the group consisting of sulfates, tartrates, citrates. lactates, oxalates, succinates, and combinations thereof

25. (canceled)

26. The delayed gelling system of claim 8 comprising from 0.05 to 50 weight percent of the polyacrylamide, from 0.5 to 20 weight percent of the partially neutralized acid aluminum salt and from 0.5 to 20 weight percent of the activator.

27. (canceled)

28. A delayed gelling system having utility in conformance control, comprising:
an acidic aqueous solution of from 0.1 to 10 weight percent cationic polyacrylamide, from 1 to 15 weight percent aluminum hydroxyl chloride, and an effective amount of an activator selected from the group consisting of urea, alkyl-substituted urea, hexamethylene tetramine, cyanates, and combinations thereof, to form a time-delayed co-gel of polyacrylamide and hydrolyzed aluminum chloride at a temperature above 120° F.

29. (canceled)

30. A method of forming a delayed polyacrylamide-inorganic co-gel, comprising:
preparing an acidic aqueous solution comprising from 0.5 to 50 weight percent acid-soluble polyacrimide, from 0.5 to 20 weight percent of an at least partially neutralized acid aluminum salt and from 0.5 to 20 weight percent of an activator comprising a Lewis base source; and
heating the aqueous soulution to a temperature for a period of time effective to form a time-delayed co-gel of polyacrylamide and hydrolyzed aluminum chloride.

31. (canceled)

32. (canceled)

33. (canceled)

34. The method of claim 30 wherein the partially neutralized aluminum salt has the formula Alₙ(OH)ₘXₚ wherein X is a mineral or organic ion or a mixture thereof with valence q, wherein pq+m=3n and a ratio m/3n is between 0.3 and 0.85.

35. The method of claim 30 wherein the partially neutralized aluminum salt comprises aluminum hydroxyl chloride.

36. The method of claim 30 wherein the activator is selected from the group consisting of urea, alkyl-substituted ureas, hexamethylene tetramine, cyanates, and combinations thereof.

37. The method of claim 36 wherein the alkyl-substituted urea is selected from the group consisting of N,N′-dimethyl urea, N,N-dimethyl urea, N,N′-diethyl urea, N,N-diethyl urea, N,N′-ethyl methyl urea, and N,N-ethyl methyl urea.

38. (canceled)

39. The method of claim 30 wherein the aqueous solution further comprises from 0.1 to 20 percent of a gel modifier selected from the group consisting of sulfates, tartrates, citrates. lactates, oxalates, succinates. and combinations thereof.

40. (canceled)

41. (canceled)

42. (canceled)

43. The method of claim 30 wherein the aqueous solution is injected into a portion of a subterranean formation and set in place at the formation temperature to inhibit water permeability of the portion of the formation, and wherein the aqueous solution is prepared at a temperature from 0 to 40° C. and the co-gel is set at a temperature above 50° C. at a setting time from 2 hours to 10 days.

44. (canceled)

45. (canceled)

46. (canceled)
